(19) United States
(12) Patent Application Publication
(10) Pub. No.: US 2021/0060501 A1
(43) Pub. Date: Mar. 4, 2021

(54) SCR SYSTEM UREA MIXER AND SCR SYSTEM

(71) Applicants: Weichai Power Co., Ltd., Shandong (CN); Weichai Power Emission Solutions Technology Co., Ltd., Shandong (CN)

(72) Inventors: Wei GAO, Shandong (CN); Xinglong LIU, Shandong (CN); Juan YAN, Shandong (CN); Dongsheng WANG, Shandong (CN); Fengshuang WANG, Shandong (CN); Yibao WANG, Shandong (CN)

(73) Assignees: Weichai Power Co., Ltd., Shandong (CN); Weichai Power Emission Solutions Technology Co., Ltd., Shandong (CN)

(21) Appl. No.: 16/958,064

(22) PCT Filed: Dec. 29, 2017
(86) PCT No.: PCT/CN2017/119693

§ 371 Date: Jun. 25, 2020

(30) Foreign Application Priority Data
Dec. 26, 2017 (CN) 201711433169.6

(51) Int. Cl. B01F 3/04; F01N 3/20; B01F 5/04; B01F 5/06; B01F 7/00; B01D 53/94

(52) U.S. Cl. CPC B01F 3/04049; F01N 3/2066; B01F 5/0451; F01N 2610/02; B01F 7/00908; B01F 7/00291; B01D 53/9431; B01F 5/0689

(57) ABSTRACT

Provided in the invention is an SCR system urea mixer. The SCR system urea mixer comprises an outer pipe and an inner pipe arranged in the outer pipe. The outer pipe comprises an air inlet cone pipe (11) and an air inlet straight pipe (12) connected with the air inlet cone pipe (11). The inner pipe comprises an air inlet rectifying pipe (21) and a porous pipe (22). The porous pipe (22) is sleeved outside the air inlet rectifying pipe (21). The air inlet rectifying pipe (21) is provided with an airstream rotating mechanism (211), and the airstream rotating mechanism (211) is used for rotating exhaust gas which enters into the air inlet cone pipe (11). A rotating structure and a porous structure are used in the SCR system urea mixer, so that urea and engine exhaust are fully mixed; and the SCR system urea mixer is provided with heat preservation measures to prevent the crystallization of the urea. Moreover, the SCR system urea mixer has no complex connection installation structure, the installation is convenient, the reliability is high, and the versatility is strong. In addition, also provided in the invention is an SCR system which is installed with the SCR system urea mixer.

### TECHNICAL FIELD

The present disclosure relates to the technical field of SCR systems for vehicle engine exhaust gas treatment, and in particular to an SCR system urea mixer and an SCR system.

### BACKGROUND

Selective Catalytic Reduction (SCR) technology refers to the use of ammonia, ammonia water, urea or hydrocarbons as reducing agents, wherein under the condition that the concentration of oxygen is two orders of magnitude higher than the concentration of NOₓ, the NOₓ is preferentially reduced into N₂ with high selectivity.

According to the type of reducing agent, existing SCR technology can be divided into urea SCR technology in which NH₃ produced by urea decomposition is used as the reducing agent and hydrocarbon SCR technology in which hydrocarbon is used as the reducing agent. At present, the hydrocarbon SCR technology is still under further research, and there are not many practical applications thereof; whereas the urea SCR technology is more mature and has more practical applications.

Being non-toxic, urea does not have a great influence on the environment and human health, and is convenient to store and transport. Therefore, it is more suitable to serve as the reducing agent for NOₓ in vehicle SCR systems. In Europe, many heavy-duty trucks with a Urea-SCR system installed thereon have already been put into use, and have successfully passed road reliability tests. However, since the freezing point of the urea aqueous solution is only −11° C., the urea may crystallize at low temperatures. In order to prevent the crystallization from affecting the operation of diesel engines, it is necessary to take corresponding heat preservation measures.

In existing urea mixers, a mixing path of exhaust gas and the urea solution is short, and the flow rate of gas is reduced after passing through mixing blades, which makes it easy to lead to urea crystallization on a back side of spiral blades and a back side of a fan structure with a spiral opening; in addition, since there is no heat preservation measures, heat dissipation of the mixer is fast, which is not advantageous for decomposition and atomization of the urea, thus resulting in urea crystallization.

### SUMMARY

The object of the present disclosure is to solve urea crystallization, and the object is achieved by the following technical solutions.

The invention provides an SCR system urea mixer, which includes an outer pipe and an inner pipe disposed in the outer pipe, wherein the outer pipe includes an intake air cone pipe and an intake air straight pipe connected with the intake air cone pipe, the inner pipe includes an intake air rectifying pipe and a porous pipe, the porous pipe is sleeved inside the intake air rectifying pipe, and the intake air rectifying pipe is provided with an airflow rotating mechanism configured to rotate exhaust gas entering the intake air cone pipe.

Further, a diameter of the intake air cone pipe gradually decreases in an inflow direction of airflow.

Further, the porous pipe extends to a middle position of the intake air straight pipe.

Further, the airflow rotating mechanism is disposed inside the intake air cone pipe.

Further, the airflow rotating mechanism is airflow rotating blades.

Further, a urea nozzle installation plate is provided at an air intake port of the SCR system urea mixer, and the urea nozzle installation plate is installed at an inlet of the intake air rectifying pipe.

Further, outer portions of the intake air cone pipe and the intake air straight pipe are each wrapped with a heat insulation shield.

Further, a heat insulation layer is disposed in the intake air cone pipe.

The present disclosure also provides an SCR system having the above SCR system urea mixer installed thereon.

Further, the SCR system is a box-type SCR system, an S-type SCR system or a U-type SCR system.

The present disclosure has the following advantages:

(1) By adopting the rotating structure and the porous structure, the present disclosure enables the urea and engine exhaust to be fully mixed, thus presenting a good mixing uniformity and effectively avoiding deposition of the urea on pipe wall.

(2) With the heat preservation measures being provided, the present disclosure can rapidly evaporate and atomize the urea solution and prevent the urea from crystallizing.

(3) Due to a modular design, the present disclosure can be applied to different engines and SCR systems, and has strong versatility.

(4) The present disclosure has no complicated connection and installation structures, is convenient to install, and has high reliability.

### BRIEF DESCRIPTION OF THE DRAWINGS

Upon reading a detailed description of the preferred embodiments below, various other advantages and benefits will become clear to those skilled in the art. The drawings are only for the purpose of illustrating the preferred embodiments, and should not be considered as limiting the present disclosure. Throughout the drawings, identical parts are denoted by identical reference signs, in which:

FIG. 1 is a schematic structural view of an SCR system urea mixer provided by an embodiment of the present disclosure;

FIG. 2 is an exploded view of an SCR system urea mixer provided by an embodiment of the present disclosure; and

FIG. 3 is a cross-sectional view of an SCR system urea mixer provided by an embodiment of the present disclosure.

### REFERENCE SIGNS IN THE DRAWINGS

11: intake air cone pipe; 12: intake air straight pipe; 21: intake air rectifying pipe; 22: porous pipe;

211: airflow rotating blade; 3: urea nozzle installation plate; 41: first heat insulation shield;

42: second heat insulation shield; 5: heat insulation layer.

### DETAILED DESCRIPTION

Hereinafter, exemplary embodiments of the present disclosure will be described in more detail with reference to the accompanying drawings. Although the exemplary embodiments of the present disclosure are shown in the drawings, it should be understood that the present disclosure can be implemented in various forms and should not be limited by the embodiments set forth herein. Rather, these embodiments are provided to enable a more thorough understanding of the present disclosure and to fully convey the scope of the present disclosure to those skilled in the art.

Exhaust gas discharged from an engine enters a post-treatment device through an air intake port, is processed by a DOC catalyst, a DPF catalyst, a urea injection and mixing unit, and an SCR catalyst in sequence, and is finally discharged from the post-treatment device.

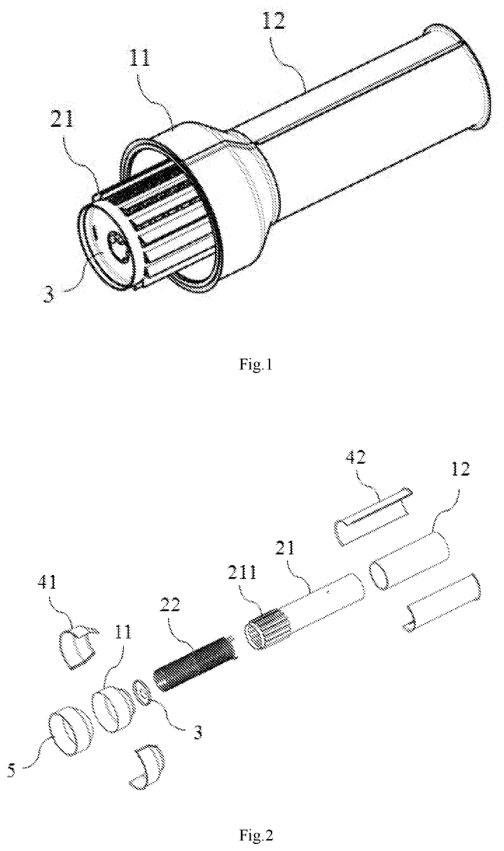

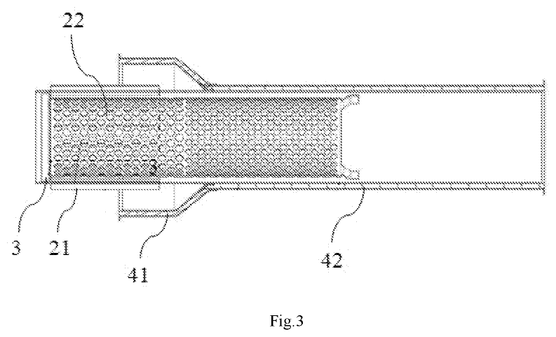

FIGS. 1 to 3 show schematic structural views of an SCR system urea mixer according to an embodiment of the present disclosure. As shown in FIGS. 1 to 3, the SCR system urea mixer includes an outer pipe and an inner pipe disposed in the outer pipe. The outer pipe includes an intake air cone pipe 11 and an intake air straight pipe 12 connected with the intake air cone pipe 11, the inner pipe includes an intake air rectifying pipe 21 and a porous pipe 22, the porous pipe 22 is sleeved inside the intake air rectifying pipe 21, and the intake air rectifying pipe 21 is provided with airflow rotating blades 211 configured to rotate exhaust gas entering the intake air cone pipe 11.

The SCR system urea mixer is provided at the air intake port thereof with a urea nozzle installation plate 3. The urea nozzle installation plate 3 is installed at an inlet of the intake air rectifying pipe 21, and the urea nozzle installation plate 3 is provided with an installation hole matching a urea nozzle which injects urea into the mixer via the installation hole so that the urea is mixed with the exhaust gas injected into the mixer.

A diameter of the intake air cone pipe 11 gradually decreases in an inflow direction of airflow. The intake air cone pipe 11 and the intake air straight pipe 12 are designed to have a reduced diameter and a smooth transition therebetween. A length of the inner porous pipe 22 extends to a middle position of the intake air straight pipe 12, so that the airflow can still pass through the inner porous pipe 22 for rotation after flowing through the blade structure of the intake air rectifying pipe 21, and the flow rate of the gas will not decrease rapidly, thereby preventing urea crystallization in the intake air straight pipe 12.

The number of pores, the diameter of pores and the arrangement of pores in the porous pipe 22 may be adjusted. In one embodiment, the diameter of pores near the intake air cone pipe 11 is larger, and the diameter of pores near the intake air straight pipe 12 is smaller, so that the urea and the airflow can be fully mixed at the intake air cone pipe 11 under the action of the airflow rotating blades 211.

In addition, outer portions of the mixer intake air cone pipe 11 and the intake air straight pipe 12 are each provided with a heat insulation shield to wrap the outer pipe so as to prevent the airflow from exchanging heat with an external airflow after entering the mixer, lowering the temperature of the exhaust gas, affecting evaporation and atomization of urea solution, and causing urea crystallization. In one embodiment, the heat insulation shield 4 is heat insulation cotton.

The outside of the intake air cone pipe 11 is wrapped with a first heat insulation shield 41, and the outside of the intake air straight pipe 12 is wrapped with a second heat insulation shield 42. In a specific embodiment, the first heat insulation shield 41 and the second heat insulation shield 42 may be integrally wrapped around the outer pipe, or may be wrapped around the intake air cone pipe 11 and the intake air straight pipe 12 respectively, which is not specifically limited herein.

In order to prevent the urea from crystallizing in the intake air cone pipe 11, a heat insulation layer 5 is also provided in the intake air cone pipe 11.

Installation angles of the airflow rotating blades 211 are all acute angles, that is, the airflow rotating blades 211 are distributed radially on the outside of the intake air rectifying pipe 21, so that the incoming airflow rotates at a high speed and forms a swirl flow.

The specific working principle of the present disclosure is as follows:

The engine exhaust gas enters the mixer through the intake air rectifying pipe 21, and the exhaust gas rotates at a high speed in the intake air cone pipe 11 under the dual action of the intake air rectifying pipe 21 and the inner porous pipe 22, so that the urea solution ejected from the urea nozzle is sufficiently mixed with the exhaust gas. The airflow further enters the intake air straight pipe 12 through the inner porous pipe 22. Under the action of the inner porous pipe 22, the airflow continues to rotate and mix in the intake air straight pipe 12, and finally flows out of the mixer through the intake air straight pipe 12.

Under the dual action of the intake air rectifying pipe 21 and the inner porous pipe 22, the airflow generates strong disturbance when it flows through the airflow rotating blades 211, which wraps and takes away the urea solution ejected from the urea nozzle. Under the action of the airflow rotating at a high speed, the urea solution is rapidly evaporated and atomized, the contact of the urea solution with an inner wall of the intake air cone pipe 11 is reduced, and urea crystallization is avoided.

In a specific embodiment, the SCR system mixer of the present disclosure can realize the modularization of the structure, may be applied to engines with different displacements, and has strong versatility. According to the operating conditions of the engine, a reasonable distribution of air flow can be achieved by adjusting the blade angle, length and number of the airflow rotating blades 211 on the intake air rectifying pipe 21; and by adjusting the number, diameter and arrangement of pores in the inner porous pipe 22, a reasonable match with the engine is achieved.

The urea mixer of the present disclosure can be applied to SCR systems with different structures, and has strong versatility. For example, it can be applied to different SCR systems such as a box-type SCR system, an S-type SCR system and a U-type SCR system.

In addition, the SCR system mixer of the present disclosure has no complicated connection and installation structures, is convenient to install, and has high reliability.

The present disclosure also provides an SCR system having the above SCR system urea mixer installed thereon.

The SCR system urea mixer provided by the present disclosure enables the urea solution to be fully mixed with the engine exhaust gas. When the airflow enters the SCR catalyst through the mixer, the distribution of NH₃ on a front end face of the SCR catalyst is more uniform, thus increasing the utilization rate of the SCR catalyst and improving the NOₓ conversion efficiency of the engine exhaust gas.

Described above are only specific preferred embodiments of the present disclosure, but the scope of protection of the present disclosure is not limited to this. Any change or replacement that can be easily contemplated by those skilled in the art within the technical scope disclosed in the present disclosure should be covered within the scope of protection of the present disclosure. Therefore, the scope of protection of the present disclosure shall be accorded with the scope of the claims.

1. An SCR system urea mixer, comprising an outer pipe and an inner pipe disposed in the outer pipe, wherein the outer pipe comprises an intake air cone pipe and an intake air straight pipe connected with the intake air cone pipe, the inner pipe comprises an intake air rectifying pipe and a porous pipe, the porous pipe is sleeved inside the intake air rectifying pipe, and the intake air rectifying pipe is provided with an airflow rotating mechanism configured to rotate exhaust gas entering the intake air cone pipe.

2. The SCR system urea mixer according to claim 1, wherein a diameter of the intake air cone pipe gradually decreases in an inflow direction of airflow.

3. The SCR system urea mixer according to claim 1, wherein the porous pipe extends to a middle position of the intake air straight pipe.

4. The SCR system urea mixer according to claim 1, wherein the airflow rotating mechanism is disposed inside the intake air cone pipe.

5. The SCR system urea mixer according to claim 4, wherein the airflow rotating mechanism is airflow rotating blades.

6. The SCR system urea mixer according to claim 1, wherein a urea nozzle installation plate is provided at an air intake port of the SCR system urea mixer, and the urea nozzle installation plate is installed at an inlet of the intake air rectifying pipe.

7. The SCR system urea mixer according to claim 1, wherein outer portions of the intake air cone pipe and the intake air straight pipe are each wrapped with a heat insulation shield.

8. The SCR system urea mixer according to claim 1, wherein a heat insulation layer is disposed in the intake air cone pipe.

9. An SCR system having the SCR system urea mixer according to claim 1 installed thereon.

10. The SCR system according to claim 9, wherein the SCR system is a box-type SCR system, an S-type SCR system or a U-type SCR system.
